(19) United States
(12) Patent Application Publication
(10) Pub. No.: US 2024/0244489 A1
(43) Pub. Date: Jul. 18, 2024

(54) NEW RADIO AND LONG TERM EVOLUTION VEHICLE-TO-EVERYTHING COEXISTENCE PROTECTION IN ADJACENT CHANNELS

(71) Applicant: QUALCOMM Incorporated, San Diego, CA (US)

(72) Inventors: Hui GUO, Beijing (CN); Tien Viet NGUYEN, Bridgewater, NJ (US); Sourjya DUTTA, San Diego, CA (US); Shuanshuan WU, San Diego, CA (US); Kapil GULATI, Belle Mead, NJ (US); Gabi SARKIS, San Diego, CA (US)

(21) Appl. No.: 18/558,074

(22) PCT Filed: Jul. 23, 2021
(86) PCT No.: PCT/CN2021/108072

§ 371 Date: Oct. 30, 2023

(51) Int. Cl. H04W 28/26; H04W 4/40; H04W 72/20

(52) U.S. Cl. CPC H04W 28/26; H04W 72/20; H04W 4/40

(57) ABSTRACT

Various aspects of the present disclosure generally relate to wireless communication. In some aspects, a first vehicle-to-every thing (V2X) device may receive, via a first radio access network (RAN), a scheduling assignment for a second V2X device. The first V2X device may decode the scheduling assignment to determine resource reservation information for the second V2X device on the first RAN. The first V2X device may modify at least one transmission associated with a second RAN based at least in part on the resource reservation information for the second V2X device on the first RAN. In some aspects, the first V2X device may transmit a coordination message for reception by one or more other V2X devices associated with a second RAN. The coordination message may include the resource reservation information for the second V2X device associated with the first RAN. Numerous other aspects are described.

### FIELD OF THE DISCLOSURE

Aspects of the present disclosure generally relate to wireless communication and to techniques and apparatuses for New Radio (NR) and Long Term Evolution (LTE) vehicle-to-everything (V2X) coexistence protection in adjacent channels.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a first vehicle-to-everything (V2X) device. The method may include receiving, by the first V2X device and via a first radio access network (RAN), a scheduling assignment for a second V2X device. The method may include decoding, by the first V2X device, the scheduling assignment to determine resource reservation information for the second V2X device on the first RAN. The method may include modifying, by the first V2X device, at least one transmission associated with a second RAN based at least in part on the resource reservation information for the second V2X device on the first RAN.

Some aspects described herein relate to a method of wireless communication performed by a first V2X device. The method may include receiving, by the first V2X device and via a first RAN, a scheduling assignment for a second V2X device. The method may include decoding, by the first V2X device, the scheduling assignment to determine resource reservation information for the second V2X device on the first RAN. The method may include transmitting, by the first V2X device, a coordination message for reception by one or more other V2X devices associated with a second RAN, the coordination message comprising the resource reservation information for the second V2X device associated with the first RAN.

Some aspects described herein relate to a method of wireless communication performed by a third V2X device. The method may include receiving, by a third V2X device and from a first V2X device, a coordination message comprising resource reservation information for a second V2X device associated with a first RAN. The method may include modifying, by the third V2X device, at least one transmission associated with a second RAN based at least in part on the resource reservation information for the second V2X device on the first RAN.

Some aspects described herein relate to a first V2X device for wireless communication. The first V2X device may include a memory and one or more processors coupled to the memory. The one or more processors may be configured to receive, via a first RAN, a scheduling assignment for a second V2X device. The one or more processors may be configured to decode the scheduling assignment to determine resource reservation information for the second V2X device on the first RAN. The one or more processors may be configured to modify at least one transmission associated with a second RAN based at least in part on the resource reservation information for the second V2X device on the first RAN.

Some aspects described herein relate to a first V2X device for wireless communication. The first V2X device may include a memory and one or more processors coupled to the memory. The one or more processors may be configured to receive, via a first RAN, a scheduling assignment for a second V2X device. The one or more processors may be configured to decode the scheduling assignment to determine resource reservation information for the second V2X device on the first RAN. The one or more processors may be configured to transmit a coordination message for reception by one or more other V2X devices associated with a second RAN, the coordination message comprising the resource reservation information for the second V2X device associated with the first RAN.

Some aspects described herein relate to a third V2X device for wireless communication. The third V2X device may include a memory and one or more processors coupled to the memory. The one or more processors may be configured to receive, from a first V2X device, a coordination message comprising resource reservation information for a second V2X device associated with a first RAN. The one or more processors may be configured to modify at least one transmission associated with a second RAN based at least in part on the resource reservation information for the second V2X device on the first RAN.

Some aspects described herein relate to a non-transitory computer-readable medium that stores a set of instructions for wireless communication by a first V2X device. The set of instructions, when executed by one or more processors of the first V2X device, may cause the first V2X device to receive, via a first RAN, a scheduling assignment for a second V2X device. The set of instructions, when executed by one or more processors of the first V2X device, may cause the first V2X device to decode the scheduling assignment to determine resource reservation information for the second V2X device on the first RAN. The set of instructions, when executed by one or more processors of the first V2X device, may cause the first V2X device to modify at least one transmission associated with a second RAN based at least in part on the resource reservation information for the second V2X device on the first RAN.

Some aspects described herein relate to a non-transitory computer-readable medium that stores a set of instructions for wireless communication by a first V2X device. The set of instructions, when executed by one or more processors of the first V2X device, may cause the first V2X device to receive, via a first RAN, a scheduling assignment for a second V2X device. The set of instructions, when executed by one or more processors of the first V2X device, may cause the first V2X device to decode the scheduling assignment to determine resource reservation information for the second V2X device on the first RAN. The set of instructions, when executed by one or more processors of the first V2X device, may cause the first V2X device to transmit a coordination message for reception by one or more other V2X devices associated with a second RAN, the coordination message comprising the resource reservation information for the second V2X device associated with the first RAN.

Some aspects described herein relate to a non-transitory computer-readable medium that stores a set of instructions for wireless communication by a third V2X device. The set of instructions, when executed by one or more processors of the third V2X device, may cause the third V2X device to receive, from a first V2X device, a coordination message comprising resource reservation information for a second V2X device associated with a first RAN. The set of instructions, when executed by one or more processors of the third V2X device, may cause the third V2X device to modify at least one transmission associated with a second RAN based at least in part on the resource reservation information for the second V2X device on the first RAN.

Some aspects described herein relate to an apparatus for wireless communication. The apparatus may include means for receiving, via a first RAN, a scheduling assignment for a second V2X device. The apparatus may include means for decoding the scheduling assignment to determine resource reservation information for the second V2X device on the first RAN. The apparatus may include means for modifying at least one transmission associated with a second RAN based at least in part on the resource reservation information for the second V2X device on the first RAN.

Some aspects described herein relate to an apparatus for wireless communication. The apparatus may include means for receiving, via a first RAN, a scheduling assignment for a second V2X device. The apparatus may include means for decoding the scheduling assignment to determine resource reservation information for the second V2X device on the first RAN. The apparatus may include means for transmitting a coordination message for reception by one or more other V2X devices associated with a second RAN, the coordination message comprising the resource reservation information for the second V2X device associated with the first RAN.

Some aspects described herein relate to an apparatus for wireless communication. The apparatus may include means for receiving, from a first V2X device, a coordination message comprising resource reservation information for a second V2X device associated with a first RAN. The apparatus may include means for modifying at least one transmission associated with a second RAN based at least in part on the resource reservation information for the second V2X device on the first RAN.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of a performance issue suffered in association with New Radio-Vehicle to Everything (NR-V2X) and Long Term Evolution-V2X (LTE-V2X) coexistence, in accordance with the present disclosure.

FIGS. 4 and 5 are diagrams illustrating examples associated with NR-V2X and LTE-V2X coexistence protection in adjacent or nearby frequency channels, in accordance with the present disclosure.

FIGS. 6-8 are diagrams illustrating example processes associated with NR-V2X LTE-V2X coexistence protection in adjacent or nearby frequency channels, in accordance with the present disclosure.

FIG. 9 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

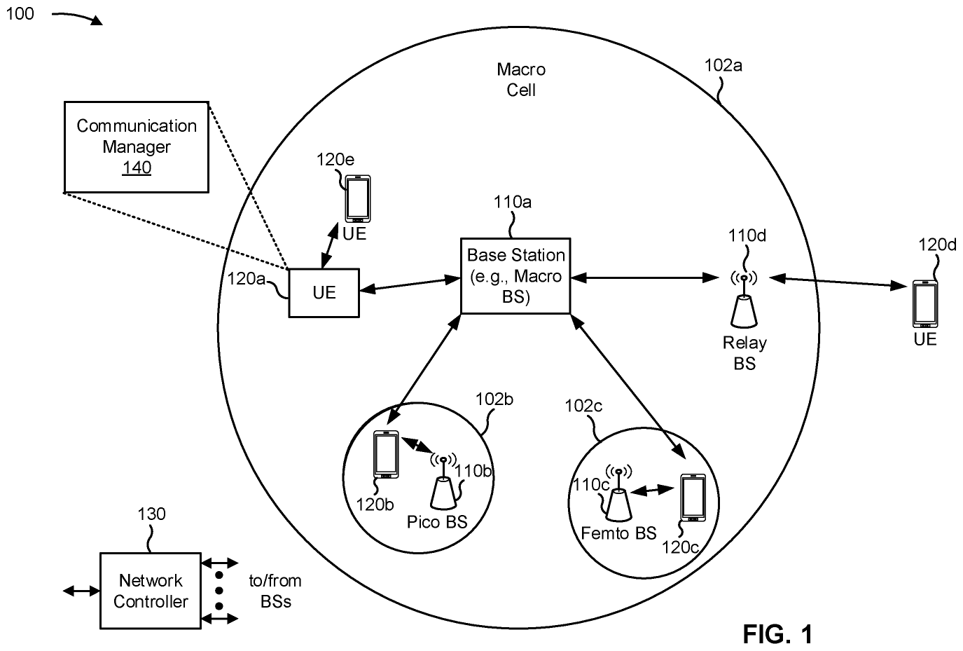

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components.

In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V21) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

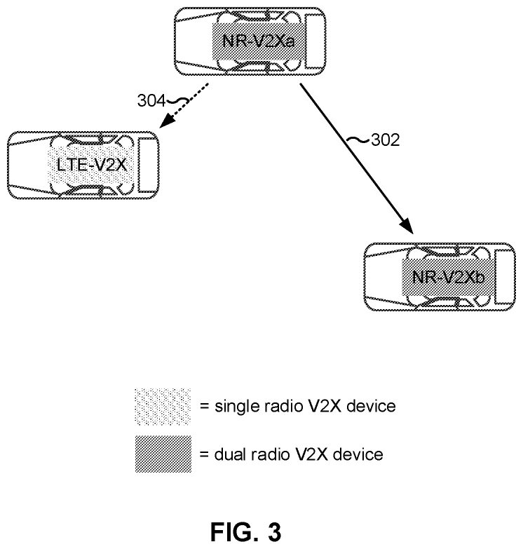

In some cases, two or more UEs 120 may communicate using a V2X protocol. Such UEs 120 are herein referred to as V2X devices. In some aspects, one or more V2X devices may be dual radio devices capable of communicating with other V2X devices via a first RAN (using a first radio) and/or a second RAN (using a second radio). Notably, one or more other V2X devices may be single radio devices capable of communicating via only the first RAN (using the single radio). As a particular example, example, a first set of V2X devices may be dual radio devices capable of communicating via an NR-V2X network (using respective first radios) and an LTE-V2X network (using respective second radios), while a second set of V2X devices may signal radio devices capable of communicating via only the LTE-V2X network (e.g., using respective single radios). Additional details regarding such V2X devices are provided below with respect to FIGS. 3A and 3B.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a first V2X device (e.g., a first UE 120) may include a communication manager 140. As described in more detail elsewhere herein, the communication manager 140 may receive, via a first RAN, a scheduling assignment for a second V2X device (e.g., a second UE 120); decode the scheduling assignment to determine resource reservation information for the second V2X device on the first RAN; and modify at least one transmission associated with a second RAN based at least in part on the resource reservation information for the second V2X device on the first RAN. Additionally, or alternatively, the communication manager may perform one or more other operations described herein.

In some aspects, a first V2X device (e.g., a first UE 120) may include a communication manager 140. As described in more detail elsewhere herein, the communication manager 140 may receive, via a first RAN, a scheduling assignment for a second V2X device (e.g., a second UE 120); decode the scheduling assignment to determine resource reservation information for the second V2X device on the first RAN; and transmit a coordination message for reception by one or more other V2X devices associated with a second RAN, the coordination message comprising the resource reservation information for the second V2X device associated with the first RAN. Additionally, or alternatively, the communication manager 140 may perform one or more other operations described herein.

In some aspects, a third V2X device (e.g., a third UE 120) may include a communication manager 140. As described in more detail elsewhere herein, the communication manager 140 may receive, from a first V2X device (e.g., a first UE 120), a coordination message comprising resource reservation information for a second V2X device (e.g., a second UE 120) associated with a first RAN; and modify at least one transmission associated with a second RAN based at least in part on the resource reservation information for the second V2X device on the first RAN. Additionally, or alternatively, the communication manager 140 may perform one or more other operations described herein.

As indicated above, FIG. 1 is provided as an example. Other examples may differ from what is described with regard to FIG. 1.

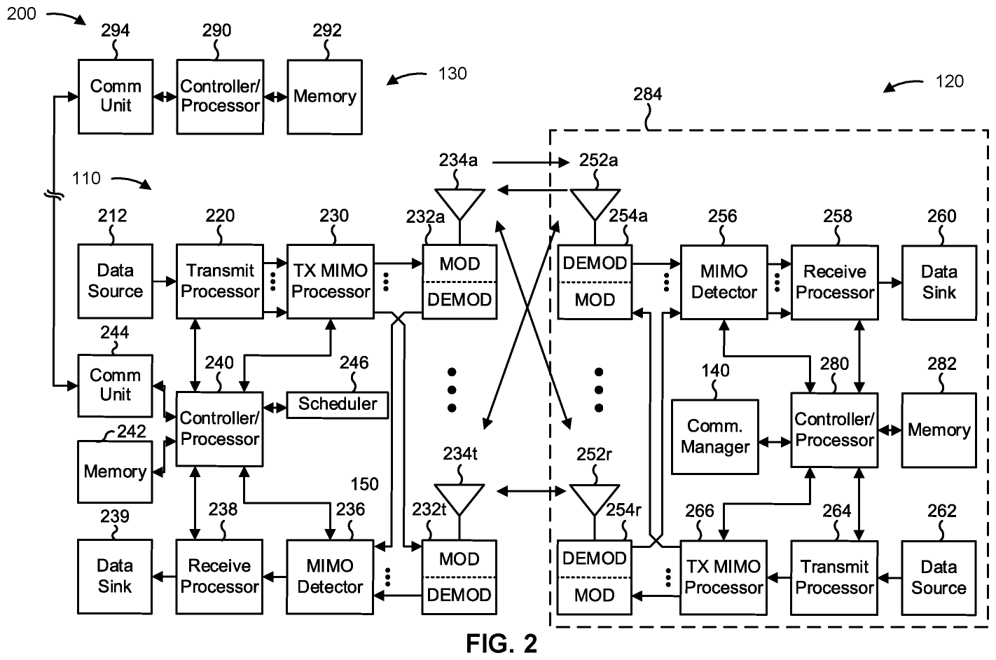

FIG. 2 is a diagram illustrating an example 200 of abase station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The UE 120 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

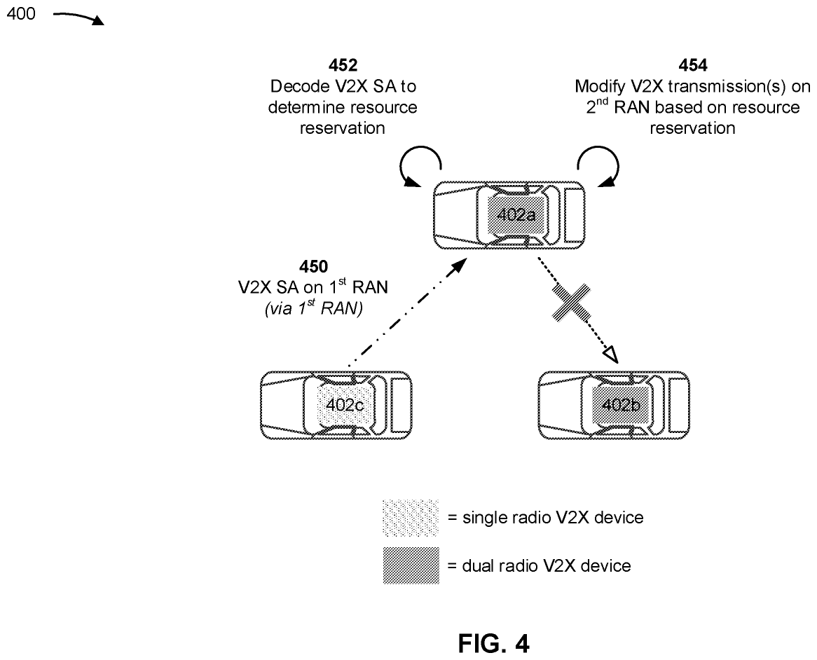

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-8).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-8).

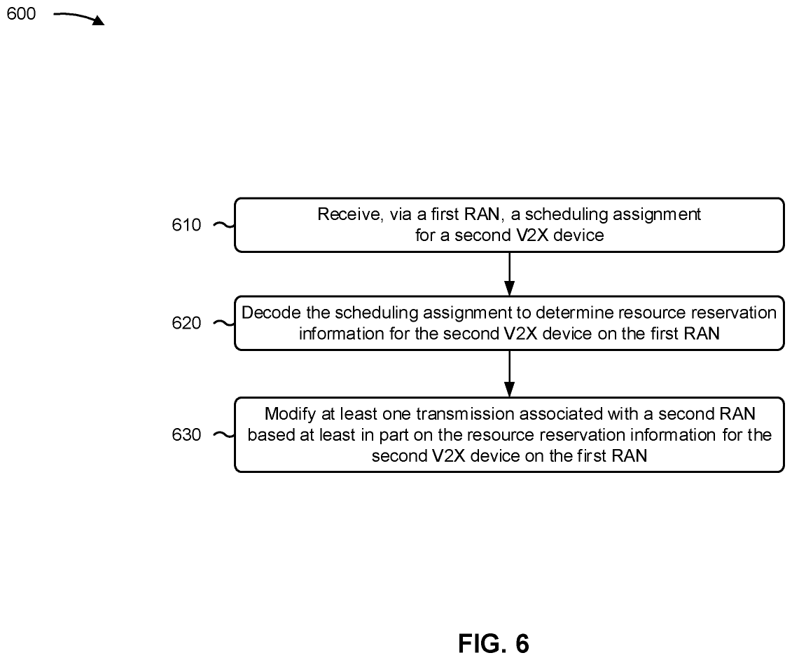

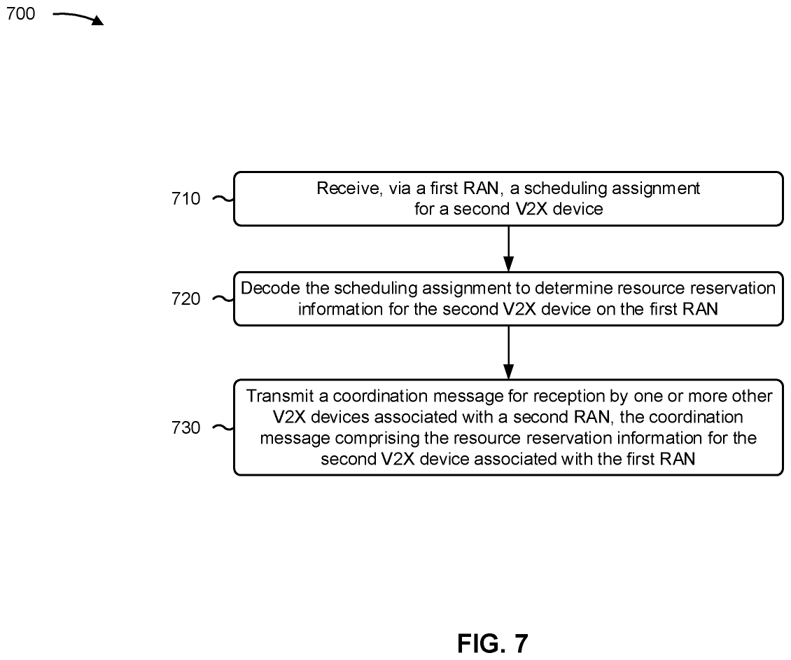

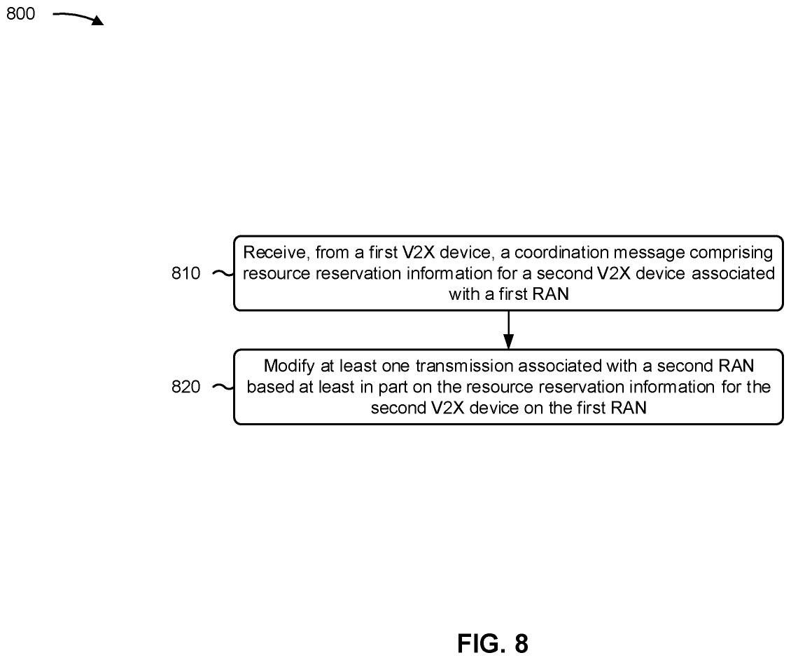

The controller/processor 240 of the base station 110, the controller/processor 280 of the UE 120, and/or any other component(s) of FIG. 2 may perform one or more techniques associated with NR-V2X and LTE-V2X coexistence protection in adjacent or nearby frequency channels, as described in more detail elsewhere herein. For example, the controller/processor 240 of the base station 110, the controller/processor 280 of the UE 120, and/or any other component(s) of FIG. 2 may perform or direct operations of, for example, process 600 of FIG. 6, process 700 of FIG. 7, process 800 of FIG. 8, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 600 of FIG. 6, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, a first V2X device (e.g., a first UE 120) includes means for receiving, via a first RAN, a scheduling assignment for a second V2X device (e.g., a second UE 120); means for decoding the scheduling assignment to determine resource reservation information for the second V2X device on the first RAN; and/or means for modifying at least one transmission associated with a second RAN based at least in part on the resource reservation information for the second V2X device on the first RAN. In some aspects, the means for the first V2X device to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a first V2X device (e.g., a first UE 120) includes means for receiving, via a first RAN, a scheduling assignment for a second V2X device (e.g., a second UE 120); means for decoding the scheduling assignment to determine resource reservation information for the second V2X device on the first RAN; and/or means for transmitting a coordination message for reception by one or more other V2X devices associated with a second RAN, the coordination message comprising the resource reservation information for the second V2X device associated with the first RAN. In some aspects, the means for the first V2X device to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a third V2X device (e.g., a third UE 120) includes means for receiving, from a first V2X device (e.g., a first UE 120), a coordination message comprising resource reservation information for a second V2X device (e.g., a second UE 120) associated with a first RAN; and/or means for modifying at least one transmission associated with a second RAN based at least in part on the resource reservation information for the second V2X device on the first RAN. In some aspects, the means for the third V2X device to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Generally, an NR-V2X device is a dual radio device that is capable of communicating via an NR network used for V2X communications (herein referred to as an NR-V2X network) and/or an LTE network used for V2X communications (herein referred to as an LTE-V2X network). For example, an NR-V2X device may be configured to transmit some communications (e.g., basic safety message (BSM) packets, cooperative awareness message (CAM) packets, or the like) via the LTE-V2X network, and to transmit other communications (e.g., advanced traffic, such as a sensor sharing message) via the NR-V2X network. Further, the NR-V2X device may receive and/or transmit scheduling assignments (SAs) (e.g., communications carrying LTE resource reservation information) via the LTE-V2X network, and may receive and/or transmit physical sidelink control channel (PSCCH) communications (e.g., communications carrying NR resource reservation information) via the NR-V2X network.

Conversely, an LTE-V2X device is typically a single radio device capable of communicating via only the LTE-V2X network. That is, an LTE-V2X device may be configured to transmit communications (e.g., BSM packets, CAM packets) via the LTE-V2X network and to receive and/or transmit SAs via the LTE-V2X network, but is not configured to receive or transmit communications via the NR-V2X network (e.g., the LTE-V2X device cannot receive or decode PSCCH communications to determine NR resource reservation information). Notably, in practice, LTE-V2X devices will need to co-exist with NR-V2X devices for some time (e.g., until NR-V2X is commercialized in large scale), and regulations governing operation of these LTE-V2X devices is fixed (i.e., cannot be changed).

In some scenarios, an NR-V2X network may utilize a frequency channel that is adjacent to or near (in the frequency domain) a frequency channel utilized by an LTE-V2X network. In such a case, NR-V2X communications and/or LTE-V2X communications can suffer from performance issues.

FIG. 3 is a diagram illustrating an example of a performance issue suffered in association with NR-V2X and LTE-V2X coexistence. In FIG. 3, a first NR-V2X device (identified as NR-V2Xa in FIG. 3) and a second NR-V2X device (identified as NR-V2Xb in FIG. 3) are dual radio devices capable of communicating via an LTE-V2X network and an NR-V2X network, while an LTE-V2X device (identified as LTE-V2X in FIG. 3) is a single radio device capable of communicating via the LTE-V2X network only. In the example shown in FIG. 3, a frequency channel to be used for NR-V2X communications is adjacent to a frequency channel to be used for LTE-V2X communications.

In one example operation, as shown by reference 302, the first NR-V2X device transmits a first V2X communication to the second NR-V2X device via an NR-V2X interface. Further, as shown by reference 304 and concurrent with the transmission of the first V2X communication, the first NR-V2X device transmits a second V2X communication to the LTE-V2X device via an LTE-V2X interface. Here, due to the near-far effect, the transmission of the first V2X communication causes interference to the LTE-V2X device. This interference can in some cases prevent the LTE-V2X device from successfully receiving or decoding the second V2X communication. Notably, neither a coordination scheme for NR-V2X and LTE-V2X operation or an effective power control mechanism is employed to prevent the interference. As a result of such issues, a packet reception ratio (PRR) degradation can be severe for the NR-V2X network and/or the LTE-V2X network.

Some aspects described herein provide techniques and apparatuses for NR-V2X and LTE-V2X coexistence protection in adjacent or nearby frequency channels.

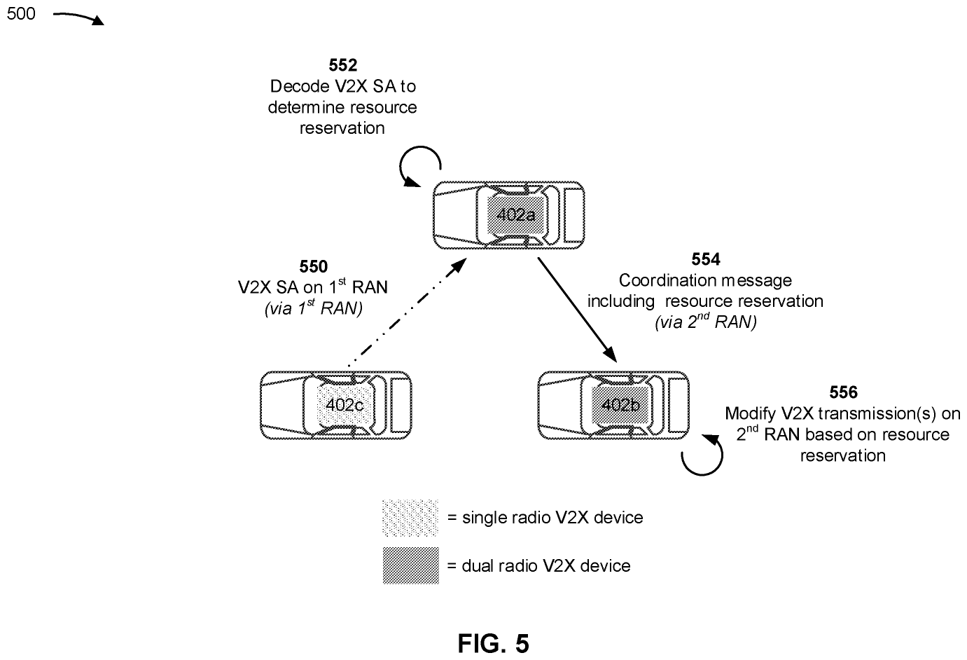

In some aspects, a first V2X device (e.g., an NR-V2X device) may receive, via a first RAN (e.g., an LTE-V2X network) a scheduling assignment for a second V2X device (e.g., an LTE-V2X device). The first V2X device may decode the scheduling assignment to determine resource reservation information for the second V2X device on the first RAN. The first V2X device may then modify at least one transmission associated with a second RAN (e.g., an NR-V2X network) based at least in part on the resource reservation information for the second V2X device on the first RAN. In some aspects, the first V2X device may transmit a coordination message for reception by one or more other V2X devices (e.g., one or more other NR-V2X devices) associated with the second RAN, where the coordination message includes the resource reservation information for the second V2X device associated with the first RAN. In some aspects, a third V2X device (e.g., another NR-V2X device) may receive the coordination message transmitted by the first V2X device, and may modify at least one transmission associated with the second RAN based at least in part on the resource reservation information for the second V2X device on the first RAN. Additional details regarding these operations are described below with respect to FIGS. 4 and 5.

In this way, NR-V2X and LTE-V2X coordination may be achieved to reduce or eliminate performance issues suffered in association with NR-V2X and LTE-V2X coexistence. For example, interference between NR-V2X communications and LTE-V2X communications may be reduced or eliminated by causing NR-V2X devices to avoid concurrent transmissions of NR-V2X communications and LTE-V2X communications, thereby reducing interference and improving a likelihood that a given V2X communication is successfully received and decoded. As a result, PRR degradation in the NR-V2X network and/or the LTE-V2X network is reduced.

Notably, while the techniques and apparatuses described herein are described in the context of NR-V2X and LTE-V2X, these techniques and apparatuses can be applied in in the context of one or more other types of V2X networks (e.g., one or more wireless networks 100 that utilize a RAT other than NR and/or LTE).

FIGS. 4 and 5 are diagrams illustrating examples 400 and 500, respectively, associated with NR-V2X and LTE-V2X coexistence protection in adjacent or nearby frequency channels, in accordance with the present disclosure. As shown in FIGS. 4 and 5, examples 400 and 500 include communication among V2X devices 402. As indicated in FIGS. 4 and 5 and as described herein, a given V2X device 402 may be a dual radio device or may be a single radio device. In examples 400 and 500, a V2X device 402a and a V2X device 402b are dual radio devices, and a V2X device 402c is a single radio device. In one particular example, the V2X device 402a is a first NR-V2X device, the V2X device 402b is a second V2X device, and the V2X device 402c is an LTE-V2X device. In some aspects, a given V2X device 402 may correspond to or include a UE 120 as described herein.

In example 400, as indicated by reference 450, the V2X device 402a receives a SA for a V2X device 402c. In some aspects, the V2X device 402a receives the SA via a first RAN. In some aspects, the first RAN is an LTE-V2X network.

In some aspects, the SA includes a communication that enables the V2X device 402a to determine resource reservation information for the V2X device 402c on the first RAN. That is, the SA includes information that, upon decoding by the V2X device 402a, indicates one or more sets of resources reserved for transmission or reception of V2X communications by the V2X device 402c on the first RAN.

As indicated by reference 452, the V2X device 402a decodes the SA to determine the resource reservation information for the V2X device 402c on the first RAN. In some aspects, as noted above, the resource reservation information indicates one or more sets of resources reserved for transmission or reception of V2X communications by the V2X device 402c on the first RAN. For example, the resource reservation information may indicate one or more resources (e.g., each resource corresponding to a sub-channel and a symbol) that are reserved in a particular slot (e.g., a current slot, a next slot, or the like) for transmission or reception of V2X communications by the V2X device 402c.

In some aspects, the resource reservation information indicates one or more sets of resources reserved for the V2X device 402c in one or more time periods, such as a current slot and one or more future slots. For example, when the first RAN is an LTE-V2X network, resource reservation may be periodic, meaning that a particular set of resources may be reserved in a current slot and one or more upcoming slots. Thus, the V2X device 402a may in some aspects determine resource reservation information indicating resources reserved for the V2X device 402c in a current time period (e.g., a current slot) and/or one or more upcoming time periods (e.g., one or more future slots).

In some aspects, the SA further includes location information associated with the V2X device 402c. For example, the SA may include information indicating a geographic location of the V2X device 402c, such as a set of coordinates (e.g., global positioning system (GPS)) coordinates corresponding to a location of the V2X device 402c. In this way, the V2X device 402a may in some aspects receive location information associated with the V2X device 402c from the V2X device 402c and via the first RAN.

As indicated by reference 454, the V2X device 402a modifies at least one transmission associated with a second RAN based at least in part on the resource reservation information for the V2X device 402c on the first RAN. In some aspects, the second RAN may be an NR-V2X network.

In some aspects, in association with modifying a given transmission, the V2X device 402a first determines that the given transmission overlaps a V2X communication scheduled by the resource reservation information in the time domain. For example, the V2X device 402a may obtain control information (e.g., carried in a PSCCH communication), associated with the second RAN, that schedules a set of transmissions by the V2X device 402a (e.g., a transmission to the V2X device 402c). Here, the V2X device 402a may compare the control information associated with the second RAN and the resource reservation information, and the V2X device 402a may determine that one or more transmissions overlap (in the time domain) a V2X communication scheduled by the resource reservation information. Notably, the at least one transmission may include one or more transmissions scheduled in a current slot and/or one or more transmissions scheduled in an upcoming slot.

In some aspects, the V2X device 402a modifies the at least one transmission further based at least in part on a determination of whether a threshold associated with modifying transmissions is satisfied. In some aspects, the V2X device 402a determines whether the threshold is satisfied based at least in part on the determination that the at least one transmission overlaps the V2X communication scheduled by the resource reservation information. In some aspects, the threshold may be a distance threshold or a signal strength threshold, as described in further detail below, or may be a threshold associated with another metric. In some aspects, the threshold can be pre-configured on the V2X device 402a (e.g., stored on the V2X device 402a during manufacture or initial configuration of the V2X device 402a). In some aspects, the threshold can be configured on the V2X device 402a via the second RAN (e.g., the threshold may be configured by a device of the second RAN). In some aspects, the threshold can be based on a configuration of the V2X device 402a (e.g., the threshold may be associated with a UE implementation).

In some aspects, as indicated above, the threshold may be a distance threshold. Thus, in some aspects, the V2X device 402a may modify the at least one transmission based at least in part on a determination that a distance between the V2X device 402a and the V2X device 402c satisfies the distance threshold (e.g., that the distance is less than or equal to a threshold distance, such as 300 meters (m), 200 m, or the like).

In some aspects, the V2X device 402a may calculate the distance between the V2X device 402a and the V2X device 402c based at least in part on the location information received from the V2X device 402c. For example, the V2X device 402a may receive a set of GPS coordinates indicating a location of the V2X device 402c, may determine (e.g., based at least in part on information stored or accessible by the V2X device 402a) a set of GPS coordinates indicating a location of the V2X device 402a, and may determine the distance between the V2X device 402a and the V2X device 402c based on these sets of GPS coordinates.

Additionally, or alternatively, the V2X device 402a may calculate the distance between the V2X device 402a and the V2X device 402c based at least in part on an RSRP value associated with receiving the SA. For example, the V2X device 402a may measure an RSRP associated with reception of the SA and may utilize an RSRP value associated with the measurement for calculation of the distance between the V2X device 402a and the V2X device 402c. In some aspects, the V2X device 402a may be configured with an algorithm that receives, as an input, the RSRP value, and provides, as an output, the distance between the V2X device 402a and the V2X device 402c.

In some aspects, after determining the distance between the V2X device 402a and the V2X device 402c, the V2X device 402a determines whether the distance is less than or equal to the threshold distance. Here, if the distance satisfies the distance threshold (e.g., is less than or equal to the threshold distance), then the V2X device 402a may modify the at least one transmission associated with the second RAN. Conversely, if the distance does not satisfy the distance threshold (e.g., is greater than the threshold distance), then the V2X device 402a may refrain from modifying the at least one transmission associated with the second RAN.

In some aspects, as indicated above, the threshold may be a signal strength threshold. Thus, in some aspects, the V2X device 402a may modify the at least one transmission based at least in part on a determination that a signal strength, associated with receiving the SA, satisfies the signal strength threshold (e.g., that the signal strength is greater than or equal to a threshold signal strength).

In some aspects, the V2X device 402a may determine the signal strength based at least in part on an RSRP value associated with receiving the SA, an RSSI associated with receiving the SA, or another signal strength metric. For example, the V2X device 402a may measure an RSRP associated with reception of the SA. The V2X device 402a may then determine whether an RSRP value is greater than or equal to the signal strength threshold. Here, if the RSRP value satisfies the signal strength threshold (e.g., is greater than or equal to the signal strength threshold), then the V2X device 402a may modify the at least one transmission associated with the second RAN. Conversely, if the RSRP value does not satisfy the signal strength threshold (e.g., is less than the signal strength threshold), then the V2X device 402a may refrain from modifying the at least one transmission associated with the second RAN.

In some aspects, modifying the at least one transmission associated with the second RAN may include dropping a packet associated with the at least one transmission (e.g., such that the transmission is canceled, as indicated in FIG. 4). Additionally, or alternatively, modifying the at least one transmission may include performing a resource re-selection associated with the at least one transmission.

In some aspects, the V2X device 402a may transmit a coordination message for reception by one or more other V2X devices 402. In some aspects, the coordination message includes the resource reservation information for the V2X device 402c on the first RAN. In some aspects the V2X device 402a may broadcast the coordination message for reception of the one or more other V2X devices 402 on the second RAN. As described with respect to example 500, a V2X device 402 that receives the coordination message may selectively modify one or more transmissions on the second RAN in a similar manner as that described above in association with reference 454.

As indicated above, FIG. 4 is provided as an example. Other examples may differ from what is described with respect to FIG. 4.

In example 500 in FIG. 5, as indicated by reference 550, a V2X device 402a (e.g., a first NR-V2X device) receives an SA for a V2X device 402c (e.g., an LTE-V2X device). In some aspects, the V2X device 402a receives the SA via a first RAN (e.g., an LTE-V2X network). In some aspects, the V2X device 402a receives the SA for the V2X device 402c in a manner similar to that described above in association with reference 450 of example 400.

As indicated by reference 552, the V2X device 402a decodes the SA to determine resource reservation information for the V2X device 402c on the first RAN. In some aspects, the V2X device 402a decodes the SA to determine resource reservation information for the V2X device 402c on the first RAN in a manner similar to that described above in association with reference 452 of example 400.

As indicated by reference 554, the V2X device 402a transmits a coordination message for reception by one or more other V2X devices associated with a second RAN (e.g., an NR-V2X network). In some aspects, the V2X device 402a transmits the coordination message via the second RAN. In some aspects, the coordination message includes the resource reservation information for the V2X device 402c associated with the first RAN. In some aspects, the V2X device 402a may broadcast the coordination message on the second RAN to enable multiple V2X devices 402 to receive the coordination message via the second RAN.

In some aspects, the coordination message may include location information associated with the V2X device 402a and/or location information associated with the V2X device 402c (e.g., location information received by the V2X device 402a from the V2X device 402c).

As further indicated by reference 554, a V2X device 402b (e.g., another NR-V2X device) receives, from the V2X device 402a, the coordination message including the resource reservation information for the V2X device 402c associated with a first RAN. For example, the V2X device 402b may receive the coordination message that is broadcast by the V2X device 402a.

As indicated by reference 556 the V2X device 402b modifies at least one transmission associated with the second RAN based at least in part on the resource reservation information for the V2X device 402b on the first RAN. In some aspects, the V2X device 402b modifies the at least one transmission in a manner similar to that described above in association with reference 454 of example 400.

In some aspects, in association with modifying a given transmission, the V2X device 402b first determines that the given transmission overlaps a V2X communication scheduled by the resource reservation information in the time domain. For example, the V2X device 402b may obtain control information (e.g., carried in a PSCCH communication), associated with the second RAN, that schedules a set of transmissions by the V2X device 402b. Here, the V2X device 402b may compare the control information associated with the second RAN and the resource reservation information, and the V2X device 402b may determine that one or more transmissions overlap (in the time domain) a V2X communication scheduled by the resource reservation information. Notably, the at least one transmission may include one or more transmissions scheduled in a current slot and/or one or more transmission scheduled in an upcoming slot.

In some aspects, the V2X device 402b modifies the at least one transmission further based at least in part on a determination of whether a threshold associated with modifying transmissions is satisfied. In some aspects, the V2X device 402b determines whether the threshold is satisfied based at least in part on the determination that the at least one transmission overlaps the V2X scheduled by the resource reservation information. In some aspects, the threshold may be a distance threshold or a signal strength threshold, as described in further detail below, or may be a threshold associated with another metric. In some aspects, the threshold can be pre-configured on the V2X device 402b (e.g., stored on the V2X device 402b during manufacture or initial configuration of the V2X device 402b). In some aspects, the threshold can be configured on the V2X device 402b via the second RAN (e.g., the threshold may be configured by a device of the second RAN). In some aspects, the threshold can be based on a configuration of the V2X device 402b (e.g., the threshold may be up to UE implementation).

In some aspects, as indicated above, the threshold may be a distance threshold. Thus, in some aspects, the V2X device 402b may modify the at least one transmission based at least in part on a determination that a distance between the V2X device 402b and the V2X device 402c satisfies the distance threshold (e.g., that the distance is less than or equal to a threshold distance, such as 300 meters (m), 200 m, or the like).

In some aspects, the V2X device 402b may calculate the distance between the V2X device 402b and the V2X device 402c based at least in part on the location information, associated with the V2X device 402c, received from the V2X device 402a in the coordination message. For example, the coordination message may include a set of GPS coordinates indicating a location of the V2X device 402c, may determine (e.g., based at least in part on information stored or accessible by the V2X device 402b) a set of GPS coordinates indicating a location of the V2X device 402b, and may determine the distance between the V2X device 402b and the V2X device 402c based on these sets of GPS coordinates.

In some aspects, after determining the distance between the V2X device 402b and the V2X device 402c, the V2X device 402b determines whether the distance is less than or equal to the threshold distance. Here, if the distance satisfies the distance threshold (e.g., is less than or equal to the threshold distance), then the V2X device 402b may modify the at least one transmission associated with the second RAN. Conversely, if the distance does not satisfy the distance threshold (e.g., is greater than the threshold distance), then the V2X device 402b may refrain from modifying the at least one transmission associated with the second RAN.

In some aspects, the V2X device 402a may modify the at least one transmission based at least in part on a determination that a distance between the V2X device 402b and the V2X device 402a satisfies the distance threshold.

In some aspects, the V2X device 402b may calculate the distance between the V2X device 402b and the V2X device 402a based at least in part on the location information received from the V2X device 402a. For example, the V2X device 402b may receive a set of GPS coordinates indicating a location of the V2X device 402a, may determine (e.g., based at least in part on information stored or accessible by the V2X device 402b) a set of GPS coordinates indicating a location of the V2X device 402b, and may determine the distance between the V2X device 402b and the V2X device 402a based on these sets of GPS coordinates.

Additionally, or alternatively, the V2X device 402b may calculate the distance between the V2X device 402b and the V2X device 402a based at least in part on an RSRP value associated with receiving the coordination message. For example, the V2X device 402b may measure an RSRP associated with reception of the coordination message, and the V2X device 402b may utilize an RSRP value associated with the measurement for calculation of the distance between the V2X device 402b and the V2X device 402a. In some aspects, the V2X device 402b may be configured with an algorithm that receives, as an input, the RSRP value, and provides, as an output, the distance between the V2X device 402b and the V2X device 402a.

In some aspects, after determining the distance between the V2X device 402b and the V2X device 402a, the V2X device 402b determines whether the distance is less than or equal to the threshold distance. Here, if the distance satisfies the distance threshold (e.g., is less than or equal to the threshold distance), then the V2X device 402b may modify the at least one transmission associated with the second RAN. Conversely, if the distance does not satisfy the distance threshold (e.g., is greater than the threshold distance), then the V2X device 402b may refrain from modifying the at least one transmission associated with the second RAN.

In some aspects, as indicated above, the threshold may be a signal strength threshold. Thus, in some aspects, the V2X device 402b may modify the at least one transmission based at least in part on a determination that a signal strength, associated with receiving the coordination message, satisfies the signal strength threshold (e.g., that the signal strength is greater than or equal to a threshold signal strength).

In some aspects, the V2X device 402b may determine the signal strength based at least in part on an RSRP value associated with receiving the coordination message, an RSSI associated with receiving the coordination message, or another signal strength metric. For example, the V2X device 402b may measure an RSRP associated with reception of the coordination message. The V2X device 402b may then determine whether an RSRP value is greater than or equal to the signal strength threshold. Here, if the RSRP value satisfies the signal strength threshold (e.g., is greater than or equal to the signal strength threshold), then the V2X device 402b may modify the at least one transmission associated with the second RAN. Conversely, if the RSRP value does not satisfy the signal strength threshold (e.g., is less than the signal strength threshold), then the V2X device 402b may refrain from modifying the at least one transmission associated with the second RAN.

In some aspects, modifying the at least one transmission associated with the second RAN may include dropping a packet associated with the at least one transmission. Additionally, or alternatively, modifying the at least one transmission may include performing a resource re-selection associated with the at least one transmission.

As indicated above, FIG. 5 is provided as an example. Other examples may differ from what is described with respect to FIG. 5.

FIG. 6 is a diagram illustrating an example process 600 performed, for example, by a first V2X device, in accordance with the present disclosure. Example process 600 is an example where the first V2X device (e.g., a first V2X device 402a, a first UE 120, or the like) performs operations associated with NR-V2X and LTE-V2X coexistence protection in adjacent or nearby frequency channels.

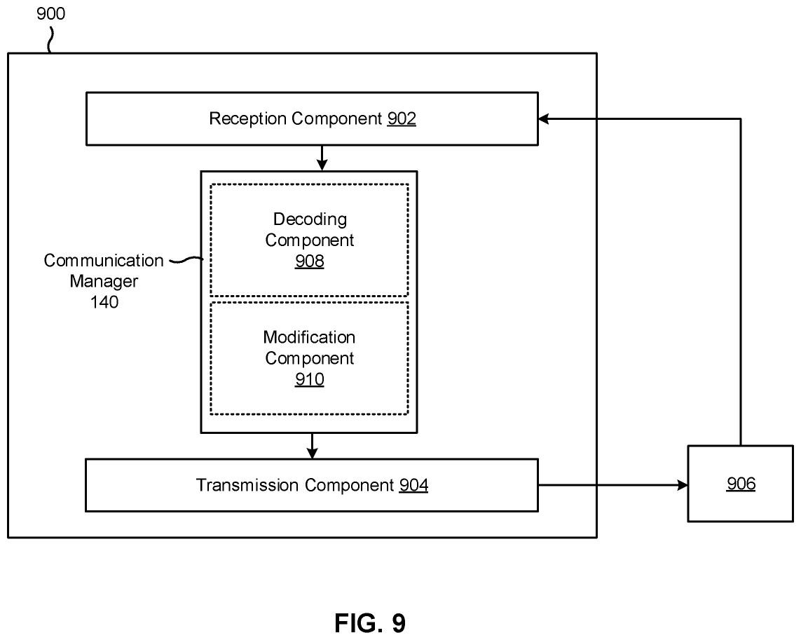

As shown in FIG. 6, in some aspects, process 600 may include receiving, via a first RAN, a scheduling assignment for a second V2X device (block 610). For example, the first V2X device (e.g., using communication manager 140 and/or reception component 902, depicted in FIG. 9) may receive, via a first RAN, a scheduling assignment for a second V2X device (e.g., a second V2X device 402c, a second UE 120, or the like), as described above.

As further shown in FIG. 6, in some aspects, process 600 may include decoding the scheduling assignment to determine resource reservation information for the second V2X device on the first RAN (block 620). For example, the first V2X device (e.g., using communication manager 140 and/or decoding component 908, depicted in FIG. 9) may decode the scheduling assignment to determine resource reservation information for the second V2X device on the first RAN, as described above.

As further shown in FIG. 6, in some aspects, process 600 may include modifying at least one transmission associated with a second RAN based at least in part on the resource reservation information for the second V2X device on the first RAN (block 630). For example, the first V2X device (e.g., using communication manager 140 and/or modification component 910, depicted in FIG. 9) may modify at least one transmission associated with a second RAN based at least in part on the resource reservation information for the second V2X device on the first RAN, as described above.

Process 600 may include additional aspects, such as any single aspect or any combination of aspects described below and/or in connection with one or more other processes described elsewhere herein.

In a first aspect, the at least one transmission is modified based at least in part on a determination that a distance between the first V2X device and the second V2X device satisfies a distance threshold.

In a second aspect, alone or in combination with the first aspect, the distance is calculated based at least in part on location information received from the second V2X device.

In a third aspect, alone or in combination with one or more of the first and second aspects, the distance is calculated based at least in part on an RSRP value associated with receiving the scheduling assignment.

In a fourth aspect, alone or in combination with one or more of the first through third aspects, the at least one transmission is modified based at least in part on a determination that a signal strength, associated with receiving the scheduling assignment, satisfies a signal strength threshold.

In a fifth aspect, alone or in combination with one or more of the first through fourth aspects, the signal strength is indicated by an RSSI or an RSRP.

In a sixth aspect, alone or in combination with one or more of the first through fifth aspects, a threshold associated with modifying the at least one transmission is pre-configured on the first V2X device.

In a seventh aspect, alone or in combination with one or more of the first through sixth aspects, a threshold associated with modifying the at least one transmission is configured on the first V2X device via the second RAN.

In an eighth aspect, alone or in combination with one or more of the first through seventh aspects, a threshold associated with modifying the at least one transmission is based on a configuration of the first V2X device.

In a ninth aspect, alone or in combination with one or more of the first through eighth aspects, modifying the at least one transmission associated with the second RAN comprises dropping a packet associated with the at least one transmission or performing a resource re-selection associated with the at least one transmission.

In a tenth aspect, alone or in combination with one or more of the first through ninth aspects, process 600 includes transmitting a coordination message for reception by one or more other V2X devices (e.g., one or more other V2X devices 402, one or more other UEs 120), the coordination message comprising the resource reservation information for the second V2X device on the first RAN.

In an eleventh aspect, alone or in combination with one or more of the first through tenth aspects, the first RAN is an LTE-V2X network, and the second RAN is an NR-V2X network.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a first V2X device, in accordance with the present disclosure. Example process 700 is an example where the first V2X device (e.g., a first V2X device 402a, a first UE 120, or the like) performs operations associated with NR-V2X and LTE-V2X coexistence protection in adjacent or nearby frequency channels.

As shown in FIG. 7, in some aspects, process 700 may include receiving, via a first RAN, a scheduling assignment for a second V2X device (block 710). For example, the first V2X device (e.g., using communication manager 140 and/or reception component 902, depicted in FIG. 9) may receive, via a first RAN, a scheduling assignment for a second V2X device (e.g., a second V2X device 402c, a second UE 120, or the like), as described above.

As further shown in FIG. 7, in some aspects, process 700 may include decoding the scheduling assignment to determine resource reservation information for the second V2X device on the first RAN (block 720). For example, the first V2X device (e.g., using communication manager 140 and/or decoding component 908, depicted in FIG. 9) may decode the scheduling assignment to determine resource reservation information for the second V2X device on the first RAN, as described above.

As further shown in FIG. 7, in some aspects, process 700 may include transmitting a coordination message for reception by one or more other V2X devices associated with a second RAN, the coordination message comprising the resource reservation information for the second V2X device associated with the first RAN (block 730). For example, the first V2X device (e.g., using communication manager 140 and/or transmission component 904, depicted in FIG. 904) may transmit a coordination message for reception by one or more other V2X devices associated with a second RAN, the coordination message comprising the resource reservation information for the second V2X device associated with the first RAN, as described above.

Process 700 may include additional aspects, such as any single aspect or any combination of aspects described below and/or in connection with one or more other processes described elsewhere herein.

In a first aspect, the coordination message comprises at least one of location information associated with the first V2X device or location information associated with the second V2X device.

In a second aspect, alone or in combination with the first aspect, the first RAN is an LTE-V2X network, and the second RAN is an NR-V2X network.

In a third aspect, alone or in combination with one or more of the first and second aspects, process 700 includes modifying at least one transmission associated with the second RAN based at least in part on the resource reservation information for the second V2X device on the first RAN.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a third V2X device, in accordance with the present disclosure. Example process 800 is an example where the third V2X device (e.g., a third V2X device 402b, a third UE 120, or the like) performs operations associated with NR-V2X and LTE-V2X coexistence protection in adjacent or nearby frequency channels.

As shown in FIG. 8, in some aspects, process 800 may include receiving, from a first V2X device, a coordination message comprising resource reservation information for a second V2X device associated with a first RAN (block 810). For example, the third V2X device (e.g., using communication manager 140 and/or reception component 902, depicted in FIG. 9) may receive, from a first V2X device (e.g., a first V2X device 402a, a first UE 120, or the like), a coordination message comprising resource reservation information for a second V2X device (e.g., a second V2X device 402b, a second UE 120, or the like) associated with a first RAN, as described above.

As further shown in FIG. 8, in some aspects, process 800 may include modifying at least one transmission associated with a second RAN based at least in part on the resource reservation information for the second V2X device on the first RAN (block 820). For example, the third V2X device (e.g., using communication manager 140 and/or modification component 910, depicted in FIG. 9) may modify at least one transmission associated with a second RAN based at least in part on the resource reservation information for the second V2X device on the first RAN, as described above.

Process 800 may include additional aspects, such as any single aspect or any combination of aspects described below and/or in connection with one or more other processes described elsewhere herein.

In a first aspect, the at least one transmission is modified based at least in part on a determination that a distance between the third V2X device and the first V2X device satisfies a distance threshold.

In a second aspect, alone or in combination with the first aspect, the distance is calculated based at least in part on location information associated with the first V2X device.

In a third aspect, alone or in combination with one or more of the first and second aspects, the distance is calculated based at least in part on an RSRP value associated with receiving the coordination message.

In a fourth aspect, alone or in combination with one or more of the first through third aspects, the at least one transmission is modified based at least in part on a determination that a signal strength, associated with receiving the coordination message, satisfies to a signal strength threshold.

In a fifth aspect, alone or in combination with one or more of the first through fourth aspects, the signal strength is indicated by an RSSI or an RSRP.

In a sixth aspect, alone or in combination with one or more of the first through fifth aspects, the at least one transmission is modified based at least in part on a determination that a distance between the third V2X device and the second V2X device satisfies a distance threshold.

In a seventh aspect, alone or in combination with one or more of the first through sixth aspects, the distance is calculated based at least in part on location information associated with the second V2X device, the location information being included in the coordination message.

In an eighth aspect, alone or in combination with one or more of the first through seventh aspects, a threshold associated with modifying the at least one transmission is pre-configured on the third V2X device.

In a ninth aspect, alone or in combination with one or more of the first through eighth aspects, a threshold associated with modifying the at least one transmission is configured on the third V2X device via the second RAN.

In a tenth aspect, alone or in combination with one or more of the first through ninth aspects, a threshold associated with modifying the at least one transmission is based on a configuration of the third V2X device.

In an eleventh aspect, alone or in combination with one or more of the first through tenth aspects, modifying the at least one transmission associated with the second RAN comprises dropping a packet associated with the at least one transmission or performing a resource re-selection associated with the at least one transmission.

In a twelfth aspect, alone or in combination with one or more of the first through eleventh aspects, the first RAN is an LTE-V2X network, and the second RAN is an NR-V2X network.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication. The apparatus 900 may be a V2X device (e.g., a V2X device 402, a UE 120), or a V2X device may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 140. The communication manager 140 may include one or more of a decoding component 908 or a modification component 910, among other examples.

In some aspects, the apparatus 900 may be configured to perform one or more operations described herein in connection with FIGS. 4 and 5 Additionally, or alternatively, the apparatus 900 may be configured to perform one or more processes described herein, such as process 600 of FIG. 6, process 700 of FIG. 7, process 800 of FIG. 8, or a combination thereof. In some aspects, the apparatus 900 and/or one or more components shown in FIG. 9 may include one or more components of the V2X device described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 906. In some aspects, the reception component 902 may include one or more antennas, a modem, a demodulator, a MIMO detector, a receive processor, a controller/processor, a memory, or a combination thereof, of the V2X device described in connection with FIG. 2.

The transmission component 904 may transmit communications, such as reference signals, control information, data communications, or a combination thereof, to the apparatus 906. In some aspects, one or more other components of the apparatus 906 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the V2X device described in connection with FIG. 2. In some aspects, the transmission component 904 may be co-located with the reception component 902 in a transceiver.

In some aspects, the reception component 902 may receive, via a first RAN, a scheduling assignment for a second V2X device. The decoding component 908 may decode the scheduling assignment to determine resource reservation information for the second V2X device on the first RAN. The modification component 910 may modify at least one transmission associated with a second RAN based at least in part on the resource reservation information for the second V2X device on the first RAN. In some aspects, the transmission component 904 may transmit a coordination message for reception by one or more other V2X devices, the coordination message comprising the resource reservation information for the second V2X device on the first RAN.

In some aspects, the reception component 902 may receive, via a first RAN, a scheduling assignment for a second V2X device. The decoding component 908 may decode the scheduling assignment to determine resource reservation information for the second V2X device on the first RAN. The transmission component 904 may transmit a coordination message for reception by one or more other V2X devices associated with a second RAN, the coordination message comprising the resource reservation information for the second V2X device associated with the first RAN. In some aspects, the modification component 910 may modify at least one transmission associated with the second RAN based at least in part on the resource reservation information for the second V2X device on the first RAN.

In some aspects, the reception component 902 may receive, from a first V2X device, a coordination message comprising resource reservation information for a second V2X device associated with a first RAN. The modification component 910 may modify at least one transmission associated with a second RAN based at least in part on the resource reservation information for the second V2X device on the first RAN.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a first V2X device, comprising: receiving, by the first V2X device and via a first RAN, a scheduling assignment for a second V2X device; decoding, by the first V2X device, the scheduling assignment to determine resource reservation information for the second V2X device on the first RAN; and modifying, by the first V2X device, at least one transmission associated with a second RAN based at least in part on the resource reservation information for the second V2X device on the first RAN.

Aspect 2: The method of Aspect 1, wherein the at least one transmission is modified based at least in part on a determination that a distance between the first V2X device and the second V2X device satisfies a distance threshold.

Aspect 3: The method of Aspect 2, wherein the distance is calculated based at least in part on location information received from the second V2X device.

Aspect 4: The method of any of Aspects 2-3, wherein the distance is calculated based at least in part on a reference signal received power (RSRP) value associated with receiving the scheduling assignment.

Aspect 5: The method of any of Aspects 1-4, wherein the at least one transmission is modified based at least in part on a determination that a signal strength, associated with receiving the scheduling assignment, satisfies a signal strength threshold.

Aspect 6: The method of Aspect 5, wherein the signal strength is indicated by an RSSI or an RSRP.

Aspect 7: The method of any of Aspects 1-6, wherein a threshold associated with modifying the at least one transmission is pre-configured on the first V2X device.

Aspect 8: The method of any of Aspects 1-6, wherein a threshold associated with modifying the at least one transmission is configured on the first V2X device via the second RAN.

Aspect 9: The method of any of Aspects 1-6, wherein a threshold associated with modifying the at least one transmission is based on a configuration of the first V2X device.

Aspect 10: The method of any of Aspects 1-9, wherein modifying the at least one transmission associated with the second RAN comprises dropping a packet associated with the at least one transmission or performing a resource re-selection associated with the at least one transmission.

Aspect 11: The method of any of Aspects 1-10, further comprising: transmitting a coordination message for reception by one or more other V2X devices, the coordination message comprising the resource reservation information for the second V2X device on the first RAN.

Aspect 12: The method of any of Aspects 1-11, wherein the first RAN is an LTE-V2X network, and the second RAN is an NR-V2X network.

Aspect 13: A method of wireless communication performed by a first V2X device, comprising: receiving, by the first V2X device and via a first RAN, a scheduling assignment for a second V2X device; decoding, by the first V2X device, the scheduling assignment to determine resource reservation information for the second V2X device on the first RAN; and transmitting, by the first V2X device, a coordination message for reception by one or more other V2X devices associated with a second RAN, the coordination message comprising the resource reservation information for the second V2X device associated with the first RAN.

Aspect 14: The method of Aspect 13, wherein the coordination message comprises at least one of location information associated with the first V2X device or location information associated with the second V2X device.

Aspect 15: The method of any of Aspects 13-14, wherein the first RAN is an LTE-V2X network, and the second RAN is an NR-V2X network.

Aspect 16: The method of any of Aspects 13-15, further comprising modifying at least one transmission associated with the second RAN based at least in part on the resource reservation information for the second V2X device on the first RAN.

Aspect 17: A method of wireless communication performed by a third V2X device, comprising: receiving, by a third V2X device and from a first V2X device, a coordination message comprising resource reservation information for a second V2X device associated with a first RAN; and modifying, by the third V2X device, at least one transmission associated with a second RAN based at least in part on the resource reservation information for the second V2X device on the first RAN.

Aspect 18: The method of Aspect 17, wherein the at least one transmission is modified based at least in part on a determination that a distance between the third V2X device and the first V2X device satisfies a distance threshold.

Aspect 19: The method of Aspect 18, wherein the distance is calculated based at least in part on location information associated with the first V2X device.

Aspect 20: The method of any of Aspects 18-19, wherein the distance is calculated based at least in part on a reference signal received power (RSRP) value associated with receiving the coordination message.

Aspect 21: The method of any of Aspects 17-20, wherein the at least one transmission is modified based at least in part on a determination that a signal strength, associated with receiving the coordination message, satisfies to a signal strength threshold.

Aspect 22: The method of Aspect 21, wherein the signal strength is indicated by an RSSI or an RSRP.

Aspect 23: The method of any of Aspects 17-22, wherein the at least one transmission is modified based at least in part on a determination that a distance between the third V2X device and the second V2X device satisfies a distance threshold.

Aspect 24: The method of Aspect 23, wherein the distance is calculated based at least in part on location information associated with the second V2X device, the location information being included in the coordination message.

Aspect 25: The method of any of Aspects 17-24, wherein a threshold associated with modifying the at least one transmission is pre-configured on the third V2X device.

Aspect 26: The method of any of Aspects 17-24, wherein a threshold associated with modifying the at least one transmission is configured on the third V2X device via the second RAN.

Aspect 27: The method of any of Aspects 17-24, wherein a threshold associated with modifying the at least one transmission is based on a configuration of the third V2X device.

Aspect 28: The method of any of Aspects 17-27, wherein modifying the at least one transmission associated with the second RAN comprises dropping a packet associated with the at least one transmission or performing a resource re-selection associated with the at least one transmission.

Aspect 29: The method of any of Aspects 17-28, wherein the first RAN is an LTE-V2X network, and the second RAN is an NR-V2X network.

Aspect 30: An apparatus for wireless communication at a device, comprising a processor; memory coupled with the processor; and instructions stored in the memory and executable by the processor to cause the apparatus to perform the method of one or more of Aspects 1-12.

Aspect 31: A device for wireless communication, comprising a memory and one or more processors coupled to the memory, the one or more processors configured to perform the method of one or more of Aspects 1-12.

Aspect 32: An apparatus for wireless communication, comprising at least one means for performing the method of one or more of Aspects 1-12.

Aspect 33: A non-transitory computer-readable medium storing code for wireless communication, the code comprising instructions executable by a processor to perform the method of one or more of Aspects 1-12.

Aspect 34: A non-transitory computer-readable medium storing a set of instructions for wireless communication, the set of instructions comprising one or more instructions that, when executed by one or more processors of a device, cause the device to perform the method of one or more of Aspects 1-12.

Aspect 35: An apparatus for wireless communication at a device, comprising a processor; memory coupled with the processor; and instructions stored in the memory and executable by the processor to cause the apparatus to perform the method of one or more of Aspects 13-16.

Aspect 36: A device for wireless communication, comprising a memory and one or more processors coupled to the memory, the one or more processors configured to perform the method of one or more of Aspects 13-16.

Aspect 37: An apparatus for wireless communication, comprising at least one means for performing the method of one or more of Aspects 13-16.

Aspect 38: A non-transitory computer-readable medium storing code for wireless communication, the code comprising instructions executable by a processor to perform the method of one or more of Aspects 13-16.

Aspect 39: A non-transitory computer-readable medium storing a set of instructions for wireless communication, the set of instructions comprising one or more instructions that, when executed by one or more processors of a device, cause the device to perform the method of one or more of Aspects 13-16.

Aspect 40: An apparatus for wireless communication at a device, comprising a processor; memory coupled with the processor; and instructions stored in the memory and executable by the processor to cause the apparatus to perform the method of one or more of Aspects 17-29.

Aspect 41: A device for wireless communication, comprising a memory and one or more processors coupled to the memory, the one or more processors configured to perform the method of one or more of Aspects 17-29.

Aspect 42: An apparatus for wireless communication, comprising at least one means for performing the method of one or more of Aspects 17-29.

Aspect 43: A non-transitory computer-readable medium storing code for wireless communication, the code comprising instructions executable by a processor to perform the method of one or more of Aspects 17-29.

Aspect 44: A non-transitory computer-readable medium storing a set of instructions for wireless communication, the set of instructions comprising one or more instructions that, when executed by one or more processors of a device, cause the device to perform the method of one or more of Aspects 17-29.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A first vehicle-to-everything (V2X) device for wireless communication, comprising:
a memory; and
one or more processors, coupled to the memory, configured to:
receive, via a first radio access network (RAN), a scheduling assignment for a second V2X device;
decode the scheduling assignment to determine resource reservation information for the second V2X device on the first RAN; and
modify at least one transmission associated with a second RAN based at least in part on the resource reservation information for the second V2X device on the first RAN.

2. The first V2X device of claim 1, wherein the at least one transmission is modified based at least in part on a determination that a distance between the first V2X device and the second V2X device satisfies a distance threshold.

3. The first V2X device of claim 2, wherein the distance is calculated based at least in part on location information received from the second V2X device.

4. The first V2X device of claim 2, wherein the distance is calculated based at least in part on a reference signal received power (RSRP) value associated with receiving the scheduling assignment.

5. The first V2X device of claim 1, wherein the at least one transmission is modified based at least in part on a determination that a signal strength, associated with receiving the scheduling assignment, satisfies a signal strength threshold.

6. The first V2X device of claim 5, wherein the signal strength is indicated by a received signal strength indicator (RSSI) or a reference signal received power (RSRP).

7. The first V2X device of claim 1, wherein a threshold associated with modifying the at least one transmission is pre-configured on the first V2X device.

8. The first V2X device of claim 1, wherein a threshold associated with modifying the at least one transmission is configured on the first V2X device via the second RAN.

9. The first V2X device of claim 1, wherein a threshold associated with modifying the at least one transmission is based on a configuration of the first V2X device.

10. The first V2X device of claim 1, wherein the one or more processors, to modify the at least one transmission associated with the second RAN, are configured to drop a packet associated with the at least one transmission or performing a resource re-selection associated with the at least one transmission.

11. The first V2X device of claim 1, wherein the one or more processors are further configured to:
transmit a coordination message for reception by one or more other V2X devices, the coordination message comprising the resource reservation information for the second V2X device on the first RAN.

12. The first V2X device of claim 1, wherein the first RAN is a Long Term Evolution (LTE)-V2X network and the second RAN is a New Radio (NR)-V2X network.

13. A first vehicle-to-everything (V2X) device for wireless communication, comprising:
a memory; and
one or more processors, coupled to the memory, configured to:
receive, via a first radio access network (RAN), a scheduling assignment for a second V2X device;
decode the scheduling assignment to determine resource reservation information for the second V2X device on the first RAN; and
transmit a coordination message for reception by one or more other V2X devices associated with a second RAN, the coordination message comprising the resource reservation information for the second V2X device associated with the first RAN.

14. The first V2X device of claim 13, wherein the coordination message comprises at least one of location information associated with the first V2X device or location information associated with the second V2X device.

15. The first V2X device of claim 13, wherein the first RAN is a Long Term Evolution (LTE)-V2X network and the second RAN is a New Radio (NR)-V2X network.

16. The first V2X device of claim 13, wherein the one or more processors are further configured to modify at least one transmission associated with the second RAN based at least in part on the resource reservation information for the second V2X device on the first RAN.

17. A third vehicle-to-everything (V2X) device for wireless communication, comprising:
a memory; and
one or more processors, coupled to the memory, configured to:
receive, from a first V2X device, a coordination message comprising resource reservation information for a second V2X device associated with a first radio access network (RAN); and
modify at least one transmission associated with a second RAN based at least in part on the resource reservation information for the second V2X device on the first RAN.

18. The third V2X device of claim 17, wherein the at least one transmission is modified based at least in part on a determination that a distance between the third V2X device and the first V2X device satisfies a distance threshold.

19. The third V2X device of claim 18, wherein the distance is calculated based at least in part on location information associated with the first V2X device.

20. The third V2X device of claim 18, wherein the distance is calculated based at least in part on a reference signal received power (RSRP) value associated with receiving the coordination message.

21. The third V2X device of claim 17, wherein the at least one transmission is modified based at least in part on a determination that a signal strength, associated with receiving the coordination message, satisfies to a signal strength threshold.

22. The third V2X device of claim 21, wherein the signal strength is indicated by a received signal strength indicator (RSSI) or a reference signal received power (RSRP).

23. The third V2X device of claim 17, wherein the at least one transmission is modified based at least in part on a determination that a distance between the third V2X device and the second V2X device satisfies a distance threshold.

24. The third V2X device of claim 23, wherein the distance is calculated based at least in part on location information associated with the second V2X device, the location information being included in the coordination message.

25. The third V2X device of claim 17, wherein a threshold associated with modifying the at least one transmission is pre-configured on the third V2X device.

26. The third V2X device of claim 17, wherein a threshold associated with modifying the at least one transmission is configured on the third V2X device via the second RAN.

27. The third V2X device of claim 17, wherein a threshold associated with modifying the at least one transmission is based on a configuration of the third V2X device.

28. The third V2X device of claim 17, wherein the one or more processors, to modify the at least one transmission associated with the second RAN, are configured to drop a packet associated with the at least one transmission or performing a resource re-selection associated with the at least one transmission.

29. The third V2X device of claim 17, wherein the first RAN is a Long Term Evolution (LTE)-V2X network and the second RAN is a New Radio (NR)-V2X network.

30. A method of wireless communication performed by a first vehicle-to-everything (V2X) device, comprising:
receiving, by the first V2X device and via a first radio access network (RAN), a scheduling assignment for a second V2X device;
decoding, by the first V2X device, the scheduling assignment to determine resource reservation information for the second V2X device on the first RAN; and
modifying, by the first V2X device, at least one transmission associated with a second RAN based at least in part on the resource reservation information for the second V2X device on the first RAN.

31-38. (canceled)
